(19) United States
(12) Patent Application Publication
(10) Pub. No.: US 2020/0134663 A1
(43) Pub. Date: Apr. 30, 2020

(54) AUTOMATIC RESOURCE ADJUSTMENT BASED ON RESOURCE AVAILABILITY

(71) Applicant: Microsoft Technology Licensing, LLC, Redmond, WA (US)

(72) Inventors: Yuan Gao, Sunnyvale, CA (US); David Pardoe, Mountain VIew, CA (US); Lijun Peng, Mountain View, CA (US); Jinyun Yan, Sunnyvale, CA (US)

(21) Appl. No.: 16/177,379

(22) Filed: Oct. 31, 2018

(51) Int. Cl. G06Q 30/02

(52) U.S. Cl. CPC G06Q 30/0249

(57) ABSTRACT

Techniques are provided for automatically adjusting a resource reduction amount based on resource availability and other factors. The following are determined for a content delivery campaign: a winning distribution for a target audience of the content delivery campaign, a through rate distribution of the content delivery campaign, a resource allocation of the content delivery campaign, and an estimated number of content item selection events in which the content delivery campaign will participate in a future time period. Based on these values, a resource reduction amount is determined. An example of a resource reduction amount is an effective cost per impression. The resource reduction amount is used in one or more subsequent content item selection events in which the content delivery campaign participates.

### TECHNICAL FIELD

The present disclosure relates to resource management in a computer environment and, more particularly to, automatically adjusting a resource reduction amount based on historical data and estimated future events.

### BACKGROUND

The Internet has enabled the delivery of electronic content to billions of people. Some entities maintain content delivery exchanges that allow different content providers to reach a wide online audience. There is a limit to the resources that are dedicated to each content delivery campaign that a content provider establishes with a content delivery exchange. It is imperative that a content delivery exchange not exceed the resource limit of any content delivery campaign. One technique to reduce the likelihood that the resource limit of a content delivery campaign is to establish a resource reduction amount that is relatively low. A resource reduction amount is an amount that is deducted from a current resource allocation if a content item from the content delivery campaign is selected for presentation. Traditionally, content providers of content delivery campaigns establish their respective resource reduction amounts. However, content providers have very little information regarding who is available for content items and when. Furthermore, there are constant changes in the rate of user interaction with the content and the delay between when those interactions occur and when data reporting those interactions are received and processed by the content delivery exchange. For example, a content delivery exchange may experience a large amount of online traffic that triggers presentation of content items during different parts of the day while, during other parts of the day, the content delivery exchange may experience a relatively low amount of such online activity. Techniques for the content delivery exchange establishing optimal resource reduction amounts for content providers are needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 depicts two plots of a comparison between two cost functions based on data from a representative content delivery campaign, in an embodiment;

FIG. 3A is a block diagram that depicts a process tree for solving for a resource reduction amount using an optimization model, in an embodiment;

FIG. 3B is a flow diagram that depicts a process for automatically determining a resource reduction amount for a content delivery campaign, in an embodiment;

FIG. 4A is a block diagram that depicts an example expected cost graph, in an embodiment;

FIG. 4B is a block diagram that depicts expected cost graph and an example projected spend graph, in an embodiment;

FIG. 5 is a flow diagram that depicts a process for determining a resource reduction amount for a content delivery campaign based on projected resource consumption, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for determining optimal resource reduction amounts for different content delivery campaigns are provided. In one technique, a ratio between an actual remaining resource allocation and a projected remaining resource allocation of a content delivery campaign is determined. A current cost of the content delivery campaign given a current resource reduction amount is determined. A new cost of the content delivery campaign is determined based on the ratio. A new resource reduction amount is determined based on the new cost. The new resource reduction amount may be used to select the content delivery campaign from among multiple candidate content delivery campaigns during a content item selection event.

In another technique, multiple attributes of a content delivery campaign are determined. Those attributes include a winning distribution, a through rate distribution, a resource allocation, and an estimated number of content item selection events [auctions] in which the content delivery campaign will participate in a future time period. Based on these attributes, a resource reduction amount for the content delivery campaign is determined. The resource reduction amount is used in one or more content item selection events in which the content delivery campaign participates.

Traditionally, a resource reduction amount for a content delivery campaign is specified by a content provider. However, the content provider does not know whether that resource reduction amount is optimal given certain constraints. For example, the content provider has no knowledge of the winning distribution of a content delivery campaign that has been activated, much less one that has yet begun. As another example, the content provider has no knowledge of the through rate distribution of a content delivery campaign, much less one that has not yet begun. Embodiments allow for the automatic determination of an optimal resource reduction amount for a content delivery campaign. Such a determination allows for the complete utilization of the campaign's allocated resources while ensuring the maximum number of won content item selection events in a particular period of time.

### System Overview

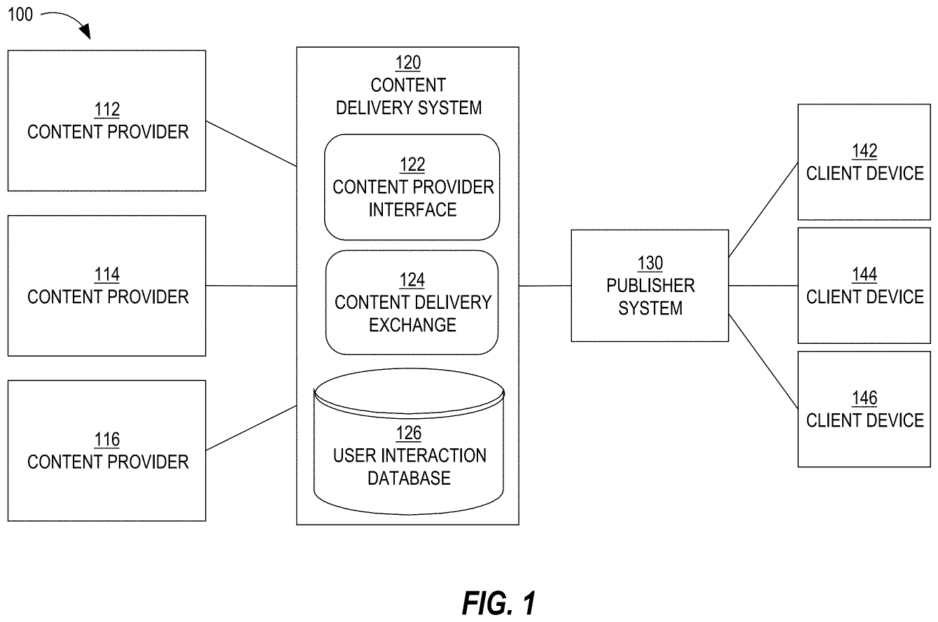

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by Linkedn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item summaries, across client devices 152-156 (and other client devices not depicted). For example, content delivery system 120 determines whether a content item summary that content delivery exchange 124 delivers is presented at (e.g., displayed by or played back at) a client device. Such an “event” is referred to as an “impression.” As another example, content delivery system 120 determines whether a content item summary that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 126. Logging such events allows content delivery system 120 to track how well different content items and/or campaigns perform.

For example, content delivery system 120 receives impression data items, each of which is associated with a different instance of an impression and a particular content item summary. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, a click data item may indicate a particular content item summary, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item. From click data items and impression data items associated with a content item summary, content delivery system 120 may calculate a CTR for the content item summary.

### Objective-Based Bid Optimization

Objective-based optimization of content delivery campaigns enables content delivery system 120 to perform automated optimizations on behalf of content providers towards their (e.g., marketing) objectives. One modeling approach is to treat all of a campaign's properties (e.g. bid, targeting) as tunable parameters and learn the optimal set of parameters for a given objective by examining the setup and performance of other campaigns. In reality, however, the set of parameters that are allowed to be auto-tuned by the system is very limited. For example, a content provider might come with strict targeting rules and a fixed amount of budget. Therefore, instead of performing global optimization, the following description focuses on a single parameter: the bid (or “resource reduction amount”). The bid is one of the parameters that some content providers may desire to allow content delivery system 120 to determine and dynamically adjust.

In the following description, an optimal bid selection algorithm is formulated as a constrained optimization problem, and an optimal bidding strategy under this formulation is derived. Additionally, multiple implementations based on different bid update frequencies are described.

### Notations

The variable ‘b’ represents an effective cost per impression (“ecpi”) bid. Different types of bids can be converted to ecpi bids. For CPM bid, the bid is b, i.e., the ecpi bid. For CPC bid, b=CPC bid*pCTR (or predicted click-through rate). For CPV (or “cost per view”) bid, b=CPV bid*pVTR (or predicted view-through rate).

The targeting criteria of a content delivery campaign defines a set of users (or “target audience”) to whom content item(s) of the campaign can be presented. The target audience determines the number of eligible auctions Nper day. A winning ecpi bid distribution under a targeting audience is denoted by q( ). (“Winning” may be defined as being selected as part of a content item selection event or resulting in an impression.)

A content delivery campaign's resource allocation (also referred to as a “budget”) is denoted by B, which may be specified by (or derived based on input from) the corresponding content provider. B is a periodic budget, such as a daily budget, an hourly budget, or a weekly budget. If a content provider specifies a total budget (the exhaustion of which effectively ends the content delivery campaign), then a B may be derived by dividing the total budget by a number of periods, such as 7, 12, 30, or 52.

The variable r represents a predicted through rate. For user selections (e.g., clicks), r is predicted click-through rate (or pCTR); for video views, r is predicted video view-through rate (or pVTR); for conversions, r is predicted conversion rate (or pCVR). Embodiments are not limited to the specific type of user action that is being predicted. A content delivery campaign's through rate distribution across all content item selection events (or auctions) is denoted by p( ).

A campaign's predicted through rate varies across content item selection events due to factors such as different member, time, and device when the content item selection events occur. All of the predicted through rates of a campaign are collected and its distribution density function is p( ). Therefore, p( ) takes a predicted through rate as input and outputs its density, which is a probability of that predicted through rate's occurrence. For example, if a campaign participated in one hundred content item selection events, in 90% of the events the predicted through rate was 0.01, and in 10% of the events the predicted through rate was 0.05, then p(0.01)=0.9 and p(0.05)=0.1.

Given the above notations and definitions, the probability of winning a content item selection event with a particular ecpi bid b is defined as

w(b)=∫₀^{b}q(z)dz

### Expected Cost

The effective cost of a content item selection event with a particular ecpi bid b is defined as

∫₀^{b}zq(z)dz

under either of the following two assumptions: (a) only the top winning content item is presented or (b) content item selection event density approaches infinity.

However, neither assumption holds for some types of content items (e.g., ones where multiple content items from a single content item selection event may be selected for presentation in, for example, a feed). Also, in reality, the previous formula only provides a lower bound. To see this, consider the winning ecpi distribution generated by the following two content item selection events:

| | top | second | other |
|---|---|---|---|
| | winning ecpi | winning ecpi | losing ads |
| Auction 1 | 3.0 | 1.0 | . . . |
| Auction 2 | 1.0 | 0.5 | . . . |

Thus, the expected cost per content item selection event at bid price 2.0 is (1.0+1.0)/2=1.0, greater than the 0.5*(½)+1*(½)=0.75 given by the formula.

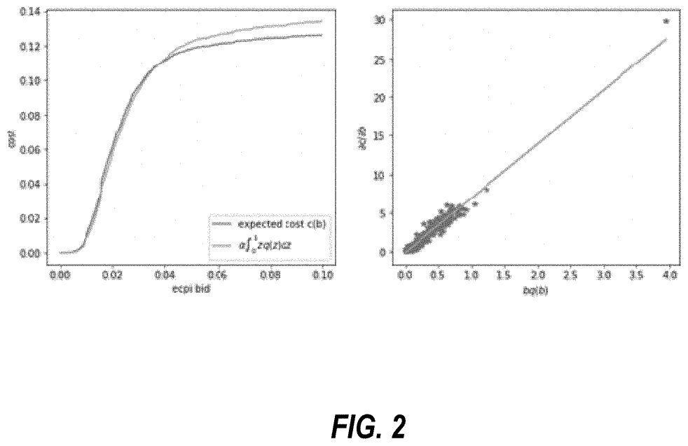

Empirically, there is any approximate linear relationship between the actual cost per auction function c(b) versus the previous formula. In a sample of ten thousand content delivery campaigns on a particular date, their expected costs c(b) under different bid prices were calculated. For each content delivery campaign, a t-test was conducted on the Pearson correlation coefficient between c(b) and ∫₀^{b} zq(z)dz. (A t-test is an analysis framework used to determine the difference between two sample means from two normally distributed populations with unknown variances. A Pearson correlation coefficient is a measure of the linear correlation between two variables.) All the content delivery campaigns have a significant linear relationship under p-value <0.05 and the average p-value across all campaigns is 9.75*10⁻⁶. FIG. 2 depicts a first plot of c(b) vs. a scaled version of ∫₀^{b} zq(z)dz as well as a second plot of their respective derivatives for a content delivery campaign. The x-axis on the first plot is the ecpi bid, while the y-axis on the first plot is expected cost. The x-axis on the second plot is bq(b) (or ecpi bid*the derivative of q( )) and the y-axis on the second plot is the derivative of c with respect to be b.

Therefore it is assumed that

c(b)=α∫₀^{b}zq(z)dz

where α is a campaign-specific coefficient that can be obtained empirically using the content item selection event history of the campaign. Thus, α is solved empirically for each content delivery campaign using historical winning ecpi bid distribution of the campaign or of the target audience of the campaign (if the campaign has little or no history). In the above-referenced study of ten thousand content delivery campaigns, the median of α is 9.8.

### UTILITY FUNCTION

In an embodiment, an objective of a content delivery campaign is mapped to a per content item selection event utility, which quantifies a benefit of winning the content item selection event. The following table illustrates the mapping:

| Objective | Utility |
|---|---|
| Impressions | 1 |
| Clicks/Conversions/ | CTR/CVR/VTR, |
| Video Views | i.e., r |
| ROI | value * r − c |

The CVR and VTR are post-impression rates, as opposed to post-click rates. If the objective of a content delivery campaign is ROI (return on investment), then the content provider of the campaign may provide the ‘value’ and c values in order to generate the utility. Because the utility is generally a function of the through rates, the utility is denoted as u(r), where, in the case of clicks r is the pCTR generated based on attributes of the user that initiated the current content item selection event. Thus, r is auction-specific, rather than an aggregated statistic.

### Problem Formulation and Solutions

In an embodiment, given the above setup, objective-based bid optimization is formulated as the following mathematical optimization problem:

max_{b(r)}∫ᵣu(r)w(b)p(r)dr, s.t. N∫ᵣc(b)p(r)dr=B.

Note that b is modeled as a function of a content delivery campaign's pctr r, so this optimization problem is essentially a functional optimization problem. The Lagrangian is

$$L ( \text{?} λ ) = {\int }_{r} u ( r ) w ( b ) p ( r ) dr - λ \text{?} c ( b ) p ( r ) dr + λ \frac{B}{N} . \\ \text{?} \text{indicates text missing or illegible when filed}$$

The Euler-Lagrange equation for b is

$$u ( r ) p ( r ) \frac{\partial w ( b ( r ) )}{\partial b ( r )} - λp ( r ) \frac{\partial c ( b ( r ) )}{\partial b ( r )} = 0.$$

By plugging in the equation for w(b) and c(b), the following is derived from the Euler-Lagrange equation:

u(r)p(r)q(b(r))−αλp(r)b(r)q(b(r))=0.

This simplifies to:

$$b ( r ) = \frac{u ( r )}{α λ}$$

with the following constraint

$$\text{?} \text{?} \text{?} zq ( z ) dzp ( r ) dr = \frac{B}{N} , \\ \text{?} \text{indicates text missing or illegible when filed}$$

where B/N is the cost per content item selection event. As the optimal ecpi bid is proportional to utility, a key is to find λ that satisfies this constraint equation. One way to find λ is using Newton's method, which is a method for finding successively better approximations to the roots (or zeroes) of a real-valued function. Newton's method is one example of a root-finding algorithm. 1/λ as a constant is (1) the ecpi bid when u(r)=1 and (2) the CPx bid (where ‘CPx’ may be CPC (cost per click), CPM (cost per thousand impressions), or CPA (cost per action or conversion) when u(r)=r.

### Example Process for Using Optimization Model

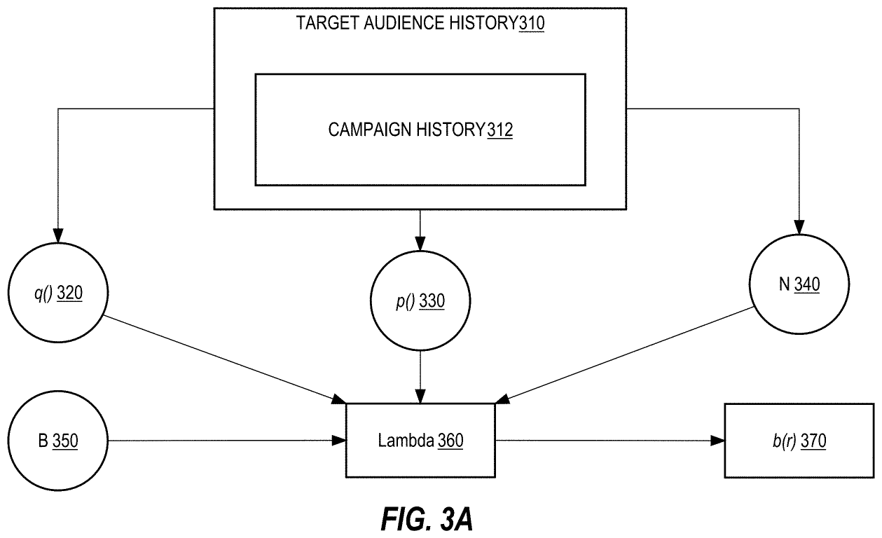

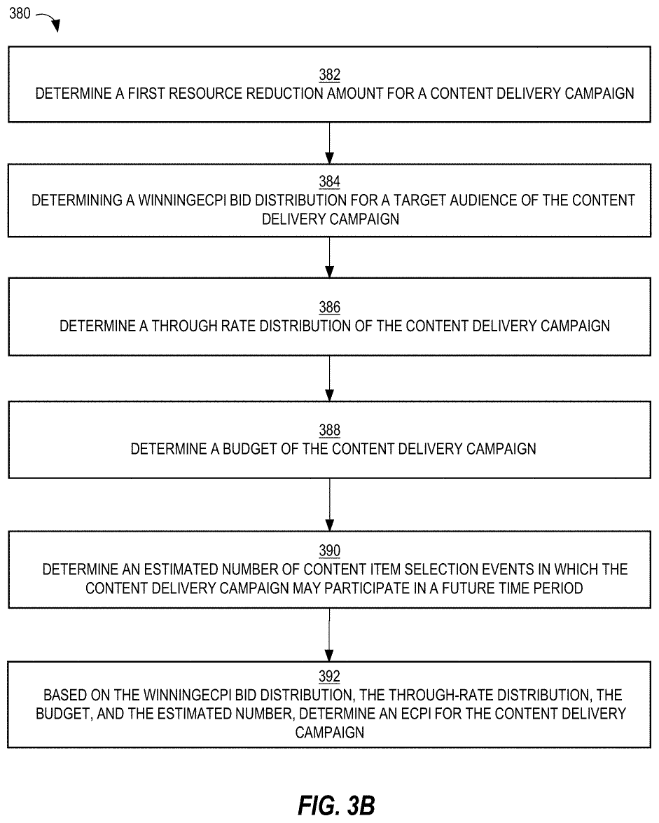

FIG. 3A is a block diagram that depicts a process tree 300 for solving for a bid using the optimization model directly, in an embodiment.

Process tree 300 includes a target audience history 310 (of content item selection events), which comprises a content delivery campaign's history 312 (of content item selection events). For new content delivery campaign, history 312 is empty. However, target audience history 310 is known and, if history 312 is non-existent or limited in amount, can be used to generating winning ecpi bid distribution (q( )) 320, through-rate distribution (p( )) 330, and size of target audience (N) 340. An example technique to estimate the size of target audience 340 is described in U.S. patent application Ser. No. 16/118,274, which is incorporated by reference as if fully disclosed herein.

Another component to process tree 300 is budget (B) 350. Given distributions 320 and 330, size of target audience 340, budget 350, λ 360 is calculated. Based on λ 360, an ecpi bid (b(r)) 370 is calculated that is proportional to u(r) and inversely proportional to λ.

Winning ecpi bid distribution 320 of a content delivery campaign is a function of time and the target audience. Winning ecpi bid distribution 320 may be approximated using historical content item selection event data generated based on interactions by members of the target audience. At least two approaches are possible: a parametric approach and a non-parametric approach.

In the parametric approach, assuming the winning ecpi bid distribution q( ) follows a log-normal distribution, the MLE (maximum likelihood estimation) estimate of the mean and variance is given by

$${\hat{u}}_{q} = \frac{1}{M} {\sum }_{i = 1}^{M} log ( \text{?} ) \text{?}$$

$$= \frac{1}{M} {\sum }_{i = 1}^{M} {( log ( \text{?} ) - \text{?} )}^{2}$$

$$\text{?} \text{indicates text missing or illegible when filed}$$

where M is a number of content item selection events in which the corresponding content delivery campaign participated. The log-normal distribution is characterized by only these two parameters: mean, and variance. Once these two parameters are known, the density function may be obtained.

In the non-parametric approach, the winning ecpi bid distribution q( ) is approximated by a histogram. For example, the histogram comprises multiple buckets, each bucket corresponding to a different, non-overlapping range of ecpi bid values. Each bucket includes a count indicating a number of content item selection events (initiated by members of the target audience) that had a winning ecpi bid value that fell into the range of that bucket. The histogram may then be used to approximate the density function. Alternatively, the value of each bucket is the value of the preceding adjacent bucket plus a count of a number of content item selection events (initiated by members of the target audience) that had a winning ecpi bid value that fell into the range of that bucket. Thus, the value of each bucket is greater than or equal to the value of the preceding bucket. The histogram may then be used to approximate the cumulative density function.

Historical through rate distribution 330 may be estimated similarly to winning ecpi bid distribution 320. One caveat is that the historical through rate of a content delivery campaign is not known at the initial phase, so a cold start model may be used. The through rate distribution of a targeting audience may act as a prior in this case, which can be preprocessed and stored.

Thus, p( ) and q( ) are similar. A similar campaign's (or targeting members') p and q may be used to estimate this campaign's p( ) and q( ). q( ) estimated in this way is more accurate because it reflects the market bid. For p( ), the best that might be done is to take one or more similar campaigns' average, but the variations in campaigns might be large.

FIG. 3B is a flow diagram that depicts a process 380 for automatically determining a bid for a content delivery campaign, in an embodiment. Process 380 may be performed by content delivery system 120.

At block 382, a first resource reduction amount (or bid) for a content delivery campaign is determined. The first resource reduction amount may be initially established by a content provider that initiated the content delivery campaign. Alternatively, the first resource reduction amount may be determined automatically using other means.

At block 384, a winning bid distribution for a target audience of the content delivery campaign is determined. Winning bid distribution may be based on past content item selection events in which the content delivery campaign participated. Alternatively, the winning bid distribution may be based on past content item selection events that members of the target audience initiated.

At block 386, a through rate distribution of the content delivery campaign across multiple content item selection events in which the content delivery campaign was a candidate is determined. In a cold-start scenario where little or no information is known about the content delivery campaign (e.g., because it is a new campaign), a default fixed bid may be used for a while or some other fallback algorithm may be used to determine a bid to be used for a while. Once the content delivery campaign is a candidate in some content item selection events, the resulting data may be used to calculate p( ). Alternatively, similar campaigns' information may be used to estimate p( ) (as explained previously), which is updated as time goes on.

At block 388, a resource allocation amount (or budget) of the particular content delivery campaign is determined. The resource allocation amount may be a periodic (e.g., a daily budget) or a total resource allocation amount that covers many periods (e.g., days). If the latter, then a periodic resource allocation amount may be calculated based on the total resource allocation amount. For example, if the total monthly budget is X, then a daily budget is X/30.

At block 390, an estimated number of content item selection events in which the particular content delivery campaign will participate in a future time period is determined. Block 390 may be performed using techniques described in U.S. patent application Ser. No. 16/118,274.

At block 392, based on the winning bid distribution, the through-rate distribution, the resource allocation amount, and the estimated number of content item selection events, an effective cost per impression (or ecpi bid) is (eventually) determined for the content delivery campaign. In fact, different parts of block 392 may be performed asynchronously. For example, the different inputs listed in block 392 are used to first calculate alpha (α) and lambda (λ) values (as described in the formulas above). After that, during serving time, in each content item selection event, a predicted through rate (e.g., pCTR) is computed and combined with the alpha and lambda values to compute the ecpi bid, which is used in ranking in a content item selection event. For example, ecpi_bid=pCTR/(alpha*lambda). If the campaign is a CPM campaign, then the optimal regular bid is 1/(alpha*lambda). If the campaign is a CPC or CPA campaign, then the computation of an ecpi bid is performed for each content item selection event in which the campaign is a candidate.

Thus, block 392 may end by simply computing the alpha and lambda values and does not necessarily include computing an effective cost per impression. Multiple content item selection events may rely on the same alpha and lambda values that are computed as a result of process 380, even though different predicted through rates may be used in each content item selection event (e.g., as a result of different users initiating the content item selection events). The product of (alpha*lambda) may be stored persistently so that the product does not have to be recomputed each time a content item selection event occurs. The product may be recalculated for each budget cycle and even at different times within a budget cycle. Process 380 may be performed frequently, as described in more detail below.

### Update Frequency

Depending on the tradeoff between accuracy and engineering complexity, the bid can be updated at different frequencies. One of three different bid adjustment models may be implemented: an offline model, a nearline model, and an online model.

In an offline model, an update to a campaign's bid is performed after every budget period, such as daily or weekly. Calculation of the optimal λ 260 is performed offline using, for example, Hadoop ETL (extraction, transformation, load) and the key value pair (campaign identifier, λ) is pushed to a distributed store for online consumption.

Hadoop is a collection of open-source software utilities that facilitate using a network of many computers to solve problems involving massive amounts of data and computation. Hadoop provides a software framework for distributed storage and processing of big data using the MapReduce programming model. Originally designed for computer clusters built from commodity hardware, Hadoop has also found use on clusters of higher-end hardware. Modules in Hadoop are designed with a fundamental assumption that hardware failures are common occurrences and should be automatically handled by the framework. The core of Hadoop consists of a storage part, known as Hadoop Distributed File System (HDFS), and a processing part which is a MapReduce programming model.

In a nearline model, an update to a campaign's bid is performed multiple times in a budget's period, such as hourly when the budget period is daily. For the estimation of winning ecpi bid distribution 320, a state server listens to an event stream of content item selection events and populates the winning ecpi bids b in a (e.g., fixed size) buffer. In the case of a parametric model, the \hat{μ}_{q},\hat{σ}_{q}² (or mean and variance) are fitted using samples in the buffer. In the case of a non-parametric model, the mean and variance are determined using the histogram.

In the nearline model, the estimation of through rate distribution 330 follows a similar process. Size of target audience 340 and budget 350 are considered, respectively, the remaining volume of content item selection events and remaining budget in the given budget period (e.g., day) and λ 360 is updated using Newton's method on a more frequent (e.g., hourly) basis. The computed key value pair (campaign identifier, λ) is pushed to a distributed store for online consumption.

In an online model, real-time updates to a campaign's bid are performed. If content delivery exchange 124 is implemented on multiple serving machines, each conducting content items selection events, then, for the parametric model of winning ecpi bid distribution 320, each serving machine maintains its own copy of the mean and variance (i.e., \hat{μ}_{q},σ_{q}²) in cache and updates these two parameters after each content item selection event. Such an update to these two parameters may be performed using one of multiple methods, such as Welford's algorithm, which is a single-pass method for computing variance. Each serving machine sends the mean and variance values to a master server that periodically (e.g., every second or every minute) averages the mean and variance values from each serving machine and broadcasts the averaged mean and variance values back to the serving machines in order to sync the parameters on each serving machine.

Similarly, for the non-parametric model of winning ecpi bid distribution 320, each serving machine maintains a copy of a normalized histogram in cache and updates the histogram in response to each content item selection event that the serving machine conducts. A master server periodically averages the histogram from each serving machine and broadcasts the averaged histogram back to serving machines to sync the parameters on each serving machine.

The estimation of through rate distribution 330 follows a similar process. Size of target audience 340 and budget 350 are considered, respectively, the remaining volume of content item selection events and the remaining budget in the given budget period (e.g., day). Also, λ 360 is updated using Newton's method in response to each content item selection event. In the case of a timeout, the previous λ in cache may be used.

If the bid update frequency is relatively high, as in the case of the online model, then pacing is inherently taken into account. If the bid update is infrequent (e.g. hourly updates using a nearline model or daily updates using an offline model), then an existing pacing system may be used to even the spend throughout a budget period (e.g., a day). Examples of pacing techniques that content delivery exchange 124 might implement are described in U.S. patent application Ser. Nos. 15/610,529 and 15/927,979, both of which are incorporated by reference as if fully disclosed herein.

### Application in Other Types of Content Item Selection Events

The above formula for determining an optimal bid assumes a second price auction (or content item selection event). The same framework may be applied to other auction schemes as well. For example, in first price auctions, the expected cost per auction c(b)=bw(b). The following optimality condition can then be derived from plugging in c(b) to the previous formula:

[u(r)−λb(r)]q(b(r))=λ∫₀^{b(r)}q(z)dz

Unlike in the second price auction case, the solution does not have an analytical form, but if it is further assumed that bid distribution q(z)=1/1 (i.e., is uniform), then the optimal bid may be derived using the following formula:

$$b ( r ) - \frac{u ( r )}{2 λ}$$

which echoes the solution in the second price auction scenario. Thus, the bid is proportional to the utility.

### Alternative Bid Adjustment Technique

The above techniques for computing an optimal bid involves estimating the distributions p and q, computing α, and estimating N. However, relying on these estimations/computations are risky because inaccuracy in any of one them would result in an error in the optimal bid. For example, it is very difficult to estimate volume N.

Therefore, in an embodiment, instead of estimating these quantities exactly, ratios over absolute numbers are used. As a result, an offline simulation is employed to obtain the expected cost per auction curve c(b) and an online proportional controller is used to perform bid adjustments based on current delivery.

The offline simulation is performed regularly, such as daily. Offline simulation may be more frequent depending on the flow's running time. For each content delivery campaign, the history of content item selection events (in which the campaign participates during the past period of time (e.g., a day)) is retrieved and those events are replayed based on bid simulation to find the expected cost per auction curve c(b). The bid that can exactly spend the budget is taken as the suggested bid. The curve, as well as the suggested bid and the budget on which it is based, are then pushed to an online store that is accessible to content delivery exchange 124.

The online portion of the embodiment involves a learning phase where the default suggested bid is used until the curve c(b) is available. In other words, the current bid is set to the suggested bid.

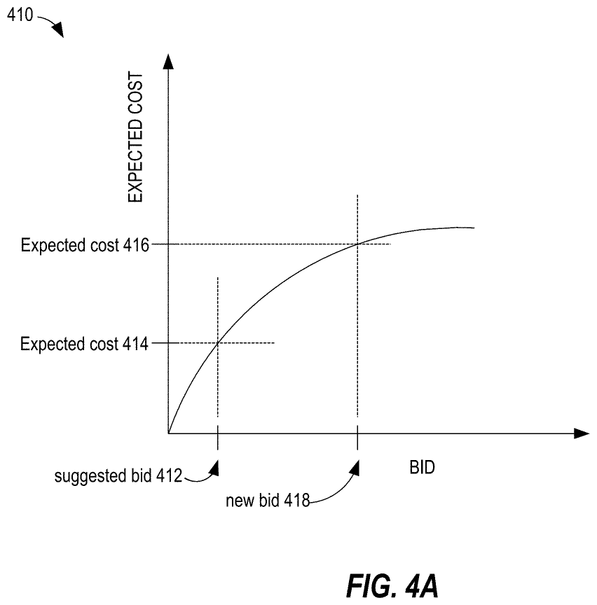

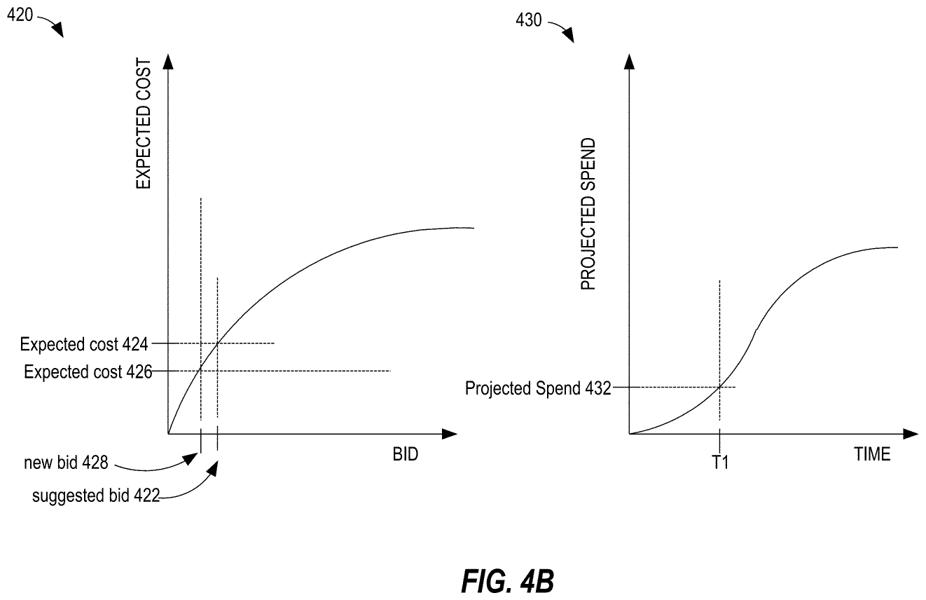

At budget reset time (e.g., UTC 0:00), the budget specified in the online store is checked to determine whether that value matches the online (current) budget. If so, then the current bid is set to be the suggestedAutoBid. If not, then a content provider of the campaign may have changed the campaign's budget. If the two budget values do not match, then a ratio of online budget/online store budget is computed and c⁻¹(c(suggestedAutoBid)*x) is set as the current bid (which is used at the start of the budget period (e.g., day)), where c(b) is the expected cost function generated from linearly interpolating the points specified in the online store. FIG. 4A shows how this might work.

FIG. 4A is a block diagram that depicts an example expected cost graph 410, in an embodiment. Expected cost graph 410 indicates a cost of a content delivery campaign for different bids. As the bid value increases, the cost increases because not only is potentially more spent on each content item selection event that is won, but also more content item selection events will be won with a higher bid value. A point on expected cost graph 410 indicates a cost of a content delivery campaign based on a particular bid value. Expected cost graph 410 may be generated based on a history of content item selection events in which the corresponding campaign participated or a history of content item selection events triggered by members of a target audience of the corresponding campaign.

For example, if the online (current) budget is twice the online store (original) budget, then the ratio is 2/1 (x=2). An expected cost 414 given suggested bid 412 is determined on expected cost graph 410, then multiplied by x (i.e., 2). The result of the multiplication is new expected cost 416, which is used to look up another point on expected cost graph 410, which point is mapped to new bid 418.

In a related embodiment, the bid is updated every more frequently, such as every ten minutes. During each update, a ratio of the actual remaining budget to the projected remaining spend (based on the pacing curve) is calculated and set to x. Then c⁻¹(c(current bid)*x) is taken as the updated bid. FIG. 4B shows how this might work. FIG. 4B is a block diagram that depicts expected cost graph 420 and an example projected spend graph 430, which indicates a projected spend of a budget over time, such as a budget period, examples of which include a day, an hour, a week, or some other time period. Projected spend graph 430 may be specific to a particular day of the week, a particular date, or may be used for multiple days, such as weekdays only. Additionally or alternatively, projected spend graph 430 is specific to a particular content delivery campaign, multiple (e.g., all) campaigns of a particular content provider, or may be used for campaigns from different content providers. A point on projected spend graph 430 indicates how much of a content delivery campaign's budget is projected to be spent at a given point in a period, such as a day.

For example, at time T1, a projected spend 432 is determined based on projected spend graph 430 and the actual spend is determined (from another data source). If the projected spend is ¾ of the actual spend (thus, “too much” actual spend has occurred), then the ratio is ¾ (i.e., x=¾). Using expected cost graph 420, expected cost 424 is determined based on suggested bid 422, which expected cost is multiplied by x (i.e., ¾). The result of the multiplication (i.e., expected cost 426) is used to look up another point on expected cost graph 420, which point is mapped to a new bid 428.

In an embodiment, pacing is implemented to ensure that the budget is not spent too quickly. One way to implement pacing is to perform a full throttle if the actual spend 5% ahead of schedule. Otherwise, no throttling is implemented.

If a content provider changes a budget of a content delivery campaign during a budget period (e.g., a day) and the projected spending curve is able capture this change, then the algorithm is not impacted. If the content provider changes one or more targeting criteria of the campaign, then c(b) would be inaccurate in a period of time, but will be updated in the next offline learning/simulation phase.

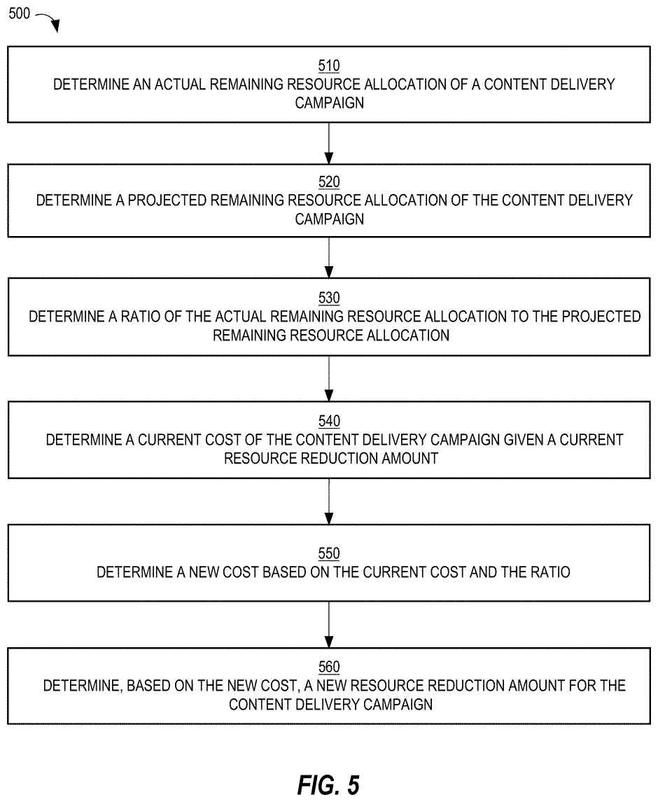

FIG. 5 is a flow diagram that depicts a process 500 for determining a resource reduction amount (e.g., bid) for a content delivery campaign based on projected resource consumption (e.g., budget spend), in an embodiment. Process 500 mirrors the process described above regarding using the projected spend and expected cost graphs.

Process 500 may be implemented by content delivery exchange 124. Alternatively, another component implement process 500 and provides the output to content delivery exchange 124 to use in one or more content item selection events involving the content delivery campaign.

Process 500 may be performed for each content delivery campaign whenever the campaign is a candidate in a content item selection event. Alternatively, process 500 may be performed for a content delivery campaign periodically regardless of the number of times the content delivery campaign is a candidate for a content item selection event. Alternatively, process 500 may be performed for a content delivery campaign for every P times the campaign is a candidate in a content item selection event.

At block 510, an actual remaining resource allocation (or actual remaining spend) of a content delivery campaign is determined. Block 510 may involve determining an actual resource usage of the content delivery campaign and subtracting that value from a total resource allocation for the content delivery campaign to generate the actual remaining resource allocation.

At block 520, a projected remaining resource allocation (or projected remaining spend) of the content delivery campaign is determined. Block 520 may involve leveraging a projected resource usage curve (e.g., reflected in projected spend graph 430) to determine the projected remaining resource allocation. For example, the projected resource usage at a particular time (e.g., the current time) is determined and subtracted from the total resource allocation for a budget period (e.g., a day). The result of the subtraction is the projected remaining resource allocation.

At block 530, a ratio of the actual remaining resource allocation to the projected remaining resource allocation is determined. Block 530 may involve dividing the first value by the second value.

At block 540, a current cost given a current resource reduction amount (e.g., current bid value) of the content delivery campaign is determined. Block 540 may be determined using an expected cost curve, such as one reflected in expected cost graph 420.

At block 550, a new cost is determined based on the current cost and the ratio. For example, the current cost is multiple by the ratio to generate the new cost.

At block 560, a new resource reduction amount (e.g., new bid value) of the content delivery campaign is determined based on the new cost.

Then, the new resource reduction amount is multiplied by a user-specific predicted through rate, such as a pCTR (e.g., if the campaign is a CPC campaign). Alternatively, the new resource reduction amount is used directly in the current (or next) content item selection event (e.g., if the campaign is a CPM campaign).

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

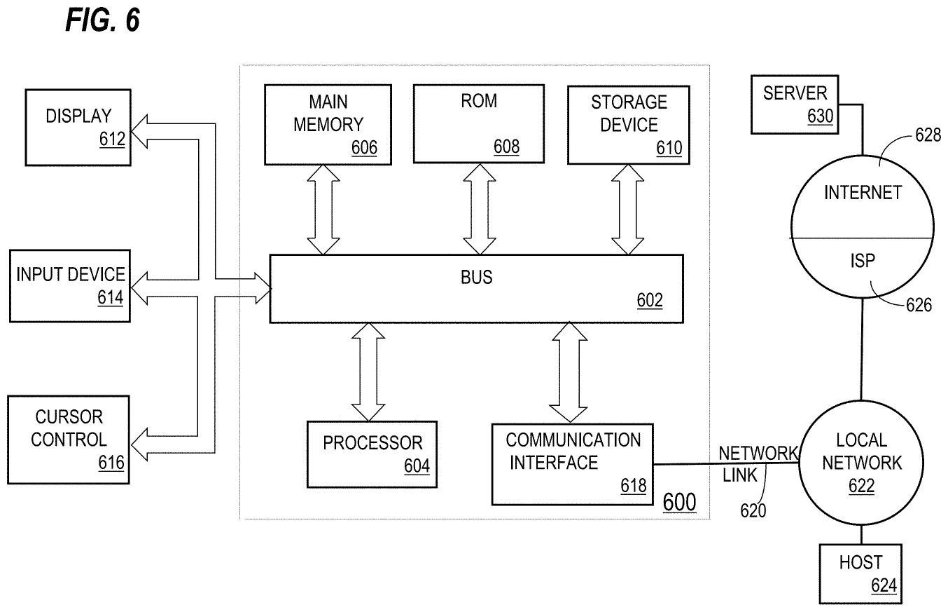

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
determining a winning distribution for a target audience of a particular content delivery campaign;
determining a through rate distribution for the particular content delivery campaign;
determining a resource allocation of the particular content delivery campaign;
determining an estimated number of content item selection events in which the particular content delivery campaign will participate in a future time period;
based on the winning distribution, the through rate distribution, the resource allocation, and the estimated number of content item selection events, determining, for the particular content delivery campaign, a resource reduction amount;
using the resource reduction amount in one or more content item selection events in which the particular content delivery campaign participates;
wherein the method is performed by one or more computing devices.

2. The method of claim 1, wherein the winning distribution is based on one or more content item selection events in which the particular content delivery campaign did not participate.

3. The method of claim 1, wherein the through rate distribution of the particular content delivery campaign is based on a plurality of content item selection events in which the particular content delivery campaign was a candidate.

4. The method of claim 1, wherein the through rate distribution of the particular content delivery campaign is based on a plurality of content item selection events that one or more members in the target audience of the particular content delivery campaign initiated, wherein the particular content delivery campaign has not yet been activated.

5. The method of claim 1, wherein the resource reduction amount is a second resource reduction amount, the method further comprising:
prior to determining the second resource reduction amount, determining, for the particular content delivery campaign, a first resource reduction amount that is different than the second resource reduction amount;
wherein the first resource reduction amount was used for one or more content delivery campaigns in which the particular content delivery campaign participated prior to determining the second resource reduction amount.

6. The method of claim 1, further comprising:
calculating a first lambda value offline, wherein the resource reduction amount is based on the first lambda value for a first period of time;
using the resource reduction amount for the particular content delivery campaign in multiple content item selection events in which the particular content delivery campaign participates in the first period of time;
after using the resource reduction amount, calculating a second lambda value offline, wherein an updated resource reduction amount for the particular content delivery campaign is based on the second lambda value for a second period of time that is subsequent to the first period of time.

7. The method of claim 1, wherein the resource reduction amount is a first resource reduction amount that is based on a first lambda value, the method further comprising:
conducting a plurality content item selection events in which the particular content delivery campaign participates based on the resource reduction amount;
wherein conducting comprises a first machine conducting a first subset of the plurality of content item selection events and a second machine conducting a second subset of the plurality of content item selection events;
receiving, by a server, (1) first events generated by the first machine based on conducting the first subset and (2) second events generated by the second machine based on conducting the second subset;
determining, by the server, a second lambda value based on the first events and the second events;
sending, by the server, the second lambda value to the first machine and the second machine for subsequent content item selection events in which the particular content delivery campaign will participate.

8. The method of claim 1, further comprising:
conducting a plurality of content item selection events in which the particular content delivery campaign participates;
wherein conducting comprises a first machine conducting a first subset of the plurality of content item selection events based on a first through rate distribution and a second machine conducting a second subset of the plurality of content item selection events based on a second through rate distribution that is different than the first through rate distribution;
updating, by the first machine, the first through rate distribution based on the first subset to generate a third through rate distribution;
updating, by the second machine, the second through rate distribution based on the second subset to generate a fourth through rate distribution;
determining, by a server, based on a third through rate distribution and the fourth through rate distribution, a fifth through rate distribution;
sending, by the server, to the first machine and the second machine, the fifth through rate distribution;
determining, by the first machine, based on the fifth through rate distribution, a first updated resource reduction amount;
determining, by the second machine, based on the fifth through rate distribution, a second updated resource reduction amount.

9. A method comprising:
determining an actual remaining resource allocation of a particular content delivery campaign;
determining a projected remaining resource allocation of the particular content delivery campaign;
determining a ratio of the actual remaining resource allocation to the projected remaining resource allocation;
identifying a current cost given a current resource reduction amount of the particular content delivery campaign;
based on the ratio, identifying a new cost;
based on the new cost, identifying a new resource reduction amount of the particular content delivery campaign;
wherein the method is performed by one or more computing devices.

10. The method of claim 9, wherein:
determining the projected remaining resource allocation comprises:
determining a current projected resource allocation based on projected resource usage curve and determining a total resource allocation for the particular content delivery campaign;
subtracting the current projected resource allocation from the total resource allocation;
determining the actual remaining resource allocation comprises:
determining a current actual resource allocation and determining the total resource allocation for the particular content delivery campaign;
subtracting the current actual resource allocation from the total resource allocation.

11. The method of claim 9, further comprising:
generating an expected cost per content item selection event curve based on a history of content item selection events in which the particular content delivery campaign was a candidate content delivery campaign;
wherein identifying the current cost comprises using the current resource reduction amount of the particular content delivery campaign and the expected cost per content item selection event curve to identify the current cost.

12. The method of claim 9, wherein the new resource reduction amount is a first resource reduction amount, wherein the first resource reduction amount is determined during a resource usage period, the method further comprising, prior to the resource usage period expiring:
determining a second projected remaining resource allocation of the particular content delivery campaign, wherein the second projected remaining resource allocation is less than the projected remaining resource allocation;
determining a second actual remaining resource allocation of the particular content delivery campaign, wherein the second actual remaining resource allocation is less than the actual remaining resource allocation;
determining a second ratio of the second projected remaining resource allocation to the second actual remaining resource allocation;
identifying a second current cost given the first resource reduction amount of the particular content delivery campaign;
based on the second ratio, identifying a second new cost;
based on the second new cost, identifying a second resource reduction amount, of the particular content delivery campaign, that is different than the first resource reduction amount.

13. One or more storage media storing instructions which, when executed by one or more processors, cause:
determining a winning distribution for a target audience of a particular content delivery campaign;
determining a through rate distribution for the particular content delivery campaign;
determining a resource allocation of the particular content delivery campaign;
determining an estimated number of content item selection events in which the particular content delivery campaign will participate in a future time period;
based on the winning distribution, the through rate distribution, the resource allocation, and the estimated number of content item selection events, determining, for the particular content delivery campaign, a resource reduction amount;
using the resource reduction amount in one or more content item selection events in which the particular content delivery campaign participates.

14. The one or more storage media of claim 13, wherein the winning distribution is based on one or more content item selection events in which the particular content delivery campaign did not participate.

15. The one or more storage media of claim 13, wherein the through rate distribution of the particular content delivery campaign is based on a plurality of content item selection events in which the particular content delivery campaign was a candidate.

16. The one or more storage media of claim 13, wherein the through rate distribution of the particular content delivery campaign is based on a plurality of content item selection events that one or more members in a target audience of the particular content delivery campaign initiated, wherein the particular content delivery campaign has not yet been activated.

17. The one or more storage media of claim 13, wherein the resource reduction amount is a second resource reduction amount, wherein the instructions, when executed by the one or more processors, further cause:
prior to determining the second resource reduction amount, determining, for the particular content delivery campaign, a first resource reduction amount that is different than the second resource reduction amount;
wherein the first resource reduction amount was used for one or more content delivery campaigns in which the particular content delivery campaign participated prior to determining the second resource reduction amount.

18. The one or more storage media of claim 13, wherein the instructions, when executed by the one or more processors, further cause:
calculating a first lambda value offline, wherein the resource reduction amount is based on the first lambda value for a first period of time;
using the resource reduction amount for the particular content delivery campaign in multiple content item selection events in which the particular content delivery campaign participates in the first period of time;
after using the resource reduction amount, calculating a second lambda value offline, wherein an updated resource reduction amount for the particular content delivery campaign is based on the second lambda value for a second period of time that is subsequent to the first period of time.

19. The one or more storage media of claim 13, wherein the resource reduction amount is a first resource reduction amount that is based on a first lambda value, wherein the instructions, when executed by the one or more processors, further cause:
conducting a plurality content item selection events in which the particular content delivery campaign participates based on the resource reduction amount;
wherein conducting comprises a first machine conducting a first subset of the plurality of content item selection events and a second machine conducting a second subset of the plurality of content item selection events;
receiving, by a server, (1) first events generated by the first machine based on conducting the first subset and (2) second events generated by the second machine based on conducting the second subset;
determining, by the server, a second lambda value based on the first events and the second events;
sending, by the server, the second lambda value to the first machine and the second machine for subsequent content item selection events in which the particular content delivery campaign will participate.

20. The one or more storage media of claim 13, wherein the instructions, when executed by the one or more processors, further cause:
conducting a plurality of content item selection events in which the particular content delivery campaign participates;
wherein conducting comprises a first machine conducting a first subset of the plurality of content item selection events based on a first through rate distribution and a second machine conducting a second subset of the plurality of content item selection events based on a second through rate distribution that is different than the first through rate distribution;
updating, by the first machine, the first through rate distribution based on the first subset to generate a third through rate distribution;
updating, by the second machine, the second through rate distribution based on the second subset to generate a fourth through rate distribution;
determining, by a server, based on a third through rate distribution and the fourth through rate distribution, a fifth through rate distribution;
sending, by the server, to the first machine and the second machine, the fifth through rate distribution;
determining, by the first machine, based on the fifth through rate distribution, a first updated resource reduction amount;
determining, by the second machine, based on the fifth through rate distribution, a second updated resource reduction amount.
